(19) United States
(12) Patent Application Publication
(10) Pub. No.: US 2015/0295971 A1
(43) Pub. Date: Oct. 15, 2015

(54) System and Method for Multi-screen Integration and Collaboration

(71) Applicant: 1Verge Internet Technology (Beijing) Co., Ltd., Beijing (CN)

(72) Inventors: Feng Wang, Beijing (CN); Hongyu Que, Beijing (CN); Jingyu Yang, Beijing (CN); Jian Yao, Beijing (CN); Baiyu Pan, Dongfang City (CN); Shuqi Lu, Beijing (CN)

(21) Appl. No.: 14/420,892

(22) PCT Filed: Aug. 30, 2013
(86) PCT No.: PCT/CN2013/082745

§ 371 Date: Feb. 10, 2015

(30) Foreign Application Priority Data
Dec. 27, 2012 (CN) 201210578746.1

(51) Int. Cl. H04L 29/06; H04L 29/08

(52) U.S. Cl. CPC H04L 65/60; H04L 67/32

(57) ABSTRACT

Disclosed herein is a system and method for multi-screen integration and coordination. The system comprises a PC terminal used as a proxy of a consumer electronics platform terminal, the consumer electronics platform terminal for remotely playing a media stream output and performing offline upload and download, offline transcoding and backup thereof, a back end service cluster subsystem for uploading, downloading, transcoding and backup, and a back end command control service system for forwarding a control command to the PC terminal. The method comprises: automatically searching for a proxy access of a PC terminal; forwarding a control command to the PC terminal; transmitting video contents to the PC terminal and uploading the video contents to a back end server, wherein the PC terminal is remotely controlled to download the video contents, or transcode the downloaded video contents, or synchronize data to the back end service cluster subsystem.

### FIELD OF THE INVENTION

The present invention relates to the field of network video applications, and more particularly, to a system and method for multi-screen integration and collaboration.

### BACKGROUND

The current trend is to allow for multi-screen integration and multi-screen collaboration. However, because different platforms (e.g., a PC terminal platform and a consumer electronics platform) operate in different operating environments, with different sets of functionalities, the existing technologies are unable to achieve real integration and collaboration between multiple platforms, and thus, cannot effectively combine the advantages of each platform, for example, the advantages of secure channel and multi-threaded upload and download at the PC terminal platform, and the portability of the consumer electronics platform.

In light of the above-stated problems, the present invention provides a solution to enable integration, complement and collaboration between video software applications on the PC terminal platform and those on the consumer electronics platform. This solution can greatly expand the functionalities of network video software and enhance the power of the network video software, thereby allowing users to better enjoy the convenient and customized services brought by the digital technologies.

Consistent with the current trend of multi-screen integration and collaboration, one scenario exists in the field of the network video software: powered by the same background support system, there is client software on both a traditional PC terminal platform and the consumer electronics platform. Although these terminal software applications running on distinct platforms may be implemented very differently, they have many overlapping functions, as well as different sets of functionalities derived by the distinctions in various platforms and computing powers. Both the PC terminal platform and the consumer electronics terminal platform have their respective advantages and strengths. By leveraging these advantages, the present invention accomplishes multi-screen integration and collaboration by providing a design that integrates and collaborates between multiple video software applications on both the PC platform terminal and the consumer electronics platform terminal.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

In view of the problems in the existing art, one embodiment of the invention provides a method

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a schematic diagram illustrating a system according to embodiments of the present invention.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, embodiments of the present invention are not intended to be limited to the examples described herein and shown, but is to be accorded the scope consistent with the claims.

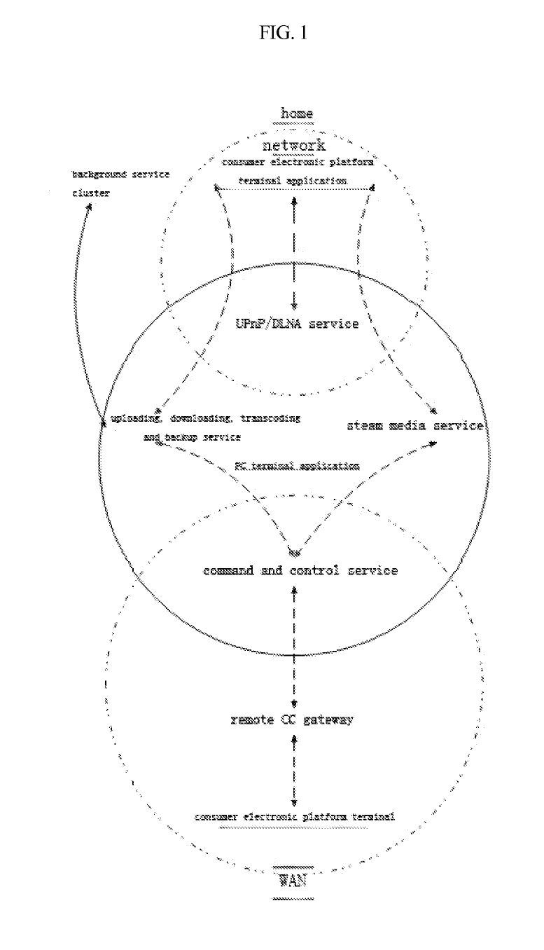

FIG. 1 is a schematic diagram illustrating the system according to embodiments of the present invention. As shown in FIG. 1, the present invention solves the problem how to integrate and coordinate network video applications running on the PC terminal platform and consumer electronics terminal platform in LAN and WAN network environments. To start with, software components as shown in FIG. 1 will be described briefly.

Network video software applications: various software applications used by the Internet users to search, play, process, produce, transmit and store network video contents.

PC terminal applications: various network video software applications running on a traditional PC terminal platform.

Consumer electronic platform terminal application: various network video software applications running on a consumer electronics platform.

Back end service cluster subsystem: a service cluster subsystem running on the back end server that performs uploading, downloading, transcoding and backup services.

UPnP/DLNA: this is a media management, automatic detection and control protocol based on the UPnP protocol commonly adopted in the industry. In one application scenario, this protocol is used to achieve zero-configuration, automatic detection and control between network video software applications running on the PC terminal and the consumer electronic platform terminal, respectively, in a home network or LAN. UPnP protocol is a distributed, open protocol architecture based on TCP/IP, HTTP, XML, SOAP and other industry standards. In general, most application scenarios have two roles: UPnP control points and UPnP devices. Obviously, UPnP control points control the UPnP devices according to the UPnP protocol. UPnP protocol architecture requires zero network configuration. That means, devices made by any vendor that comply with UPnP protocol can dynamically join the network at any time, obtain an IP network address, announce services they can provide, detect other devices in the network and know the services provided by these other devices. Through the SSDP protocol in the UPnP standards, all the entities in the UPnP network can detect and identify each other: UPnP control points can control UPnP devices by sending SOAP messages. UPnP AV standard is designed and proposed to provide for interoperability between Media Server and Media Renderer made by different vendors.

UDTB: an abbreviation of uploading, downloading, transcoding and backup. In certain circumstances, the PC terminal, subject to the bandwidth, storage space, energy consumption and so on, can act as a proxy for uploading, downloading, transcoding and providing backup of the network video applications in the consumer electronic platform terminal. In this operation, video applications in the traditional PC terminal may assist the network video applications in the consumer electronic platform terminal with such functions as offline upload, offline download, offline transcoding, automatic synchronization and offline backup. Using the SSDP protocol of the UPnP standards, the consumer electronic terminal can detect the PC terminal with zero configuration, and furthermore, the consumer electronic terminal can use the PC terminal as a proxy so that it can acquire access to uploading, downloading, transcoding and backup services on the PC terminal. More specifically, uploading means that, based on the SSDP protocol, the consumer electronic terminal detects the PC terminal, and further, through the UPnP interface description, the consumer electronic terminal detects the upload access in the PC terminal; thereafter, the consumer electronic terminal uploads video contents to the PC terminal over the network, and then the PC terminal uploads the video contents. Downloading means that, based on the SSDP protocol, the consumer electronic terminal detects the PC terminal, and further, through the UPnP interface description, the consumer electronic terminal detects the download access in the PC terminal; thereafter, the consumer electronic terminal submits a request to the PC terminal for the address of the video contents to be downloaded, and the PC terminal starts downloading. During or after the download, the consumer electronic terminal may synchronize part or all of the downloaded contents between the PC terminal and the electronic terminal. Transcoding means that, based on the SSDP protocol, the consumer electronic terminal detects the PC terminal, and further, through the UPnP interface description, the consumer electronic terminal identifies the transcoding access in the PC terminal; thereafter, the consumer electronic terminal uploads video contents to be transcoded to the PC terminal, and the PC terminal transcodes the contents and synchronizes the contents back to the consumer electronic terminal after the transcoding is done. Backup means that, based on the SSDP protocol, the consumer electronic terminal detects the PC terminal, and through the UPnP interface description, the consumer electronic terminal identifies the backup access in the PC terminal; thereafter, the consumer electronic terminal synchronizes data with the PC terminal, and the PC terminal synchronizes the data with the back end service cluster system.

Media stream service: this media stream is a flow output after the original video contents is processed by the network video application software in the PC terminal, which can be remotely played by the video application software on the consumer electronic platform terminal, such as televisions, mobile phones, tablet computers and so on. Based on the SSDP protocol, the consumer electronic terminal detects the PC terminal, and further, through the UPnP interface description, the consumer electronic terminal identifies the media stream broadcasting access in the PC terminal. The network video software on the PC terminal can also produce the media stream output directly for network broadcasting.

Command control service: this is a control component in the PC terminal application, which enables remote access and remote control by use of a secure channel. Essentially, this component acts as a proxy service that handles the input, processing and output of those commands remotely received from the consumer electronics platform. These remote commands or instructions can not only control the network video applications on the PC terminal to implement uploading, downloading, transcoding, backup and other functions immediately or in a grace period, but also transmit video content data so as to allow remote viewing of the media stream videos on the PC terminal. The consumer electronic terminal logs into the remote CC (command control) gateway as follows: in view of that both the remote CC gateway and the command control service reside in the back end system, and that there are communication channels between the PC terminal and the command control service back end system, also communication channels between the remote CC gateway and the command service back end system, the command control service back end system is only used to forward commands, while the CC gateway not only provides login access, but also perform authority verification and security auditing. In operation, the consumer electronics terminal logs into the remote CC gateway, subject to the security and authority verification in the login process, and identifies the PC terminal to be controlled in a command; once the command passes the security and authority verification, the CC gateway forwards the command to the command control service, which then passes the command words to the identified PC terminal. After the entire logical path is established, the consumer electronics terminal is provided with a seemingly local control over the network video software on the PC terminal to operate various video applications. Since not every PC terminal has a global accessible IP address, when the CC (command and control) gateway operates in a public network environment, the command control service may operate as a reverse proxy to allow the PC terminal to create the communication tunnels with the consumer electronic platform terminal after NAT (Network Address Translation), thereby enabling the command control with the consumer electronics platform terminal. With the technology of SSL Secure Sockets Layer protocol, secure and encrypted channels can be established to ensure security of the data streams.

In a LAN environment, the process of collaboration between a PC terminal platform and a consumer electronics platform works as follows: following the DLNA/UPnP protocol, the consumer electronics terminal platform starts an automatic search; once the access for the network video application software on the PC terminal is found, the consumer electronics terminal platform may play the video content with the media stream service provided by the network video software on the PC terminal; or may control the network video application software on the PC terminal as a proxy to upload, download, transcode, backup and so on. For more convenient, the network video applications on the PC terminal can transcode the downloaded video contents directly into audio and video encoding format and applicable video readable format that are compatible with the consumer electronics platform.

In a LAN environment, the process of collaboration between a PC terminal platform and a consumer electronics platform works as follows: the consumer electronics platform terminal logs into the CC gateway and creates secure and reliable communication tunnels with the PC terminal after NAT through the CC gateway. Once remote communication tunnels are established, uploading, downloading, transcoding and backup service and media stream service can be made available just like in LAN.

1. With regard to video data upload and download, the PC terminal platform provides better computing power than the consumer electronics platform. In certain circumstances, using the PC terminal platform for data upload and download can also greatly reduce the data streaming cost in the consumer electronics platform. In addition, by re-assigning the task of uploading and downloading video contents to the PC terminal, users can use the consumer electronics platforms to perform other operations.

2. With regard to transcoding, the limited resources on the consumer electronics platform make it difficult to implement transcoding. This can be overcome by re-assigning the task of transcoding from the consumer electronics platform to the PC terminal platform.

3. With regard to backup, some of the audio and video data on the consumer electronics platform can be automatically synchronized and backed up to the PC terminal platform or the network server, which enhances the software functionality, ensures data security and increases the user loyalty to the software. Once the network video application on the consumer electronics terminal detects an access to the network video applications on the PC terminal, it can synchronizes data with the PC terminal, from where a network application on the PC terminal can automatically synchronize the data with the back end service cluster subsystem.

Since the PC terminal application supports UPnP/DLNA and media stream services, it can integrate or collaborate with various video application software on the consumer electronic platform terminal that complies with SSDP protocol, thereby providing a considerable interoperability.

In one example, there is a large amount of selfie video content by a mobile phone to be uploaded to the back end server in the network. The consumer electronics platform terminal (i.e., the mobile phone), by means of SSDP protocol, automatically detects a PC terminal and an access for the upload service on the PC terminal. As a result, the consumer electronics platform terminal can quickly transfer the video content to the PC terminal. Then, the PC terminal can quickly upload the relevant video content through a multi-thread process to the back end upload server in the network.

In another example, the consumer electronics platform terminal can arrange in advance for the PC terminal to download the video content from the network through a network accelerator. The consumer electronics platform logs into the CC gateway, and by the reverse proxy function of the command control service, establishes secure and reliable communication tunnels with the PC terminal. Once the communication tunnels are created, those tasks to be performed can be submitted to the video applications on the PC terminal in advance. Meanwhile, the consumer electronics platform terminal can also submit a remote query regarding the download progress.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

What is claimed is:

1. A system for multi-screen integration and coordination, comprising:
a PC terminal with one or more first network video applications running thereon, the PC terminal configured as a proxy of a consumer electronics platform terminal for performing upload, download, transcoding and a backup tasks;
the consumer electronics platform terminal with one or more second network video applications running thereon, the consumer electronics platform configured for remotely playing a media stream output of the first network video applications running on the PC terminal and performing upload, download, transcoding and backup tasks offline;
a back end service cluster subsystem running on a back end server, the subsystem configured for performing uploading, downloading, transcoding and backup tasks;
a command control service back end system configured for forwarding a control command from the consumer electronics platform terminal to the PC terminal to control the first network video applications running on the PC terminal to perform uploading, downloading, transcoding and backup tasks and allow a remote viewing of media stream videos on the PC terminal.

2. The system according to claim 1, further comprising a remote command and control (CC) gateway in a WAN, wherein the CC gateway allows secure and reliable communication channels to be established between the consumer electronics platform terminal and the PC terminal after network address translation (NAT), through which the consumer electronic terminal remotely controls the PC terminal.

3. The system according to claim 1, wherein the consumer electronic platform terminal detects the PC terminal through the SSDP protocol of the UPnP standards, and uses the PC terminal as a proxy to perform upload, download, transcoding and backup tasks through an access on the PC terminal.

4. The system according to claim 1, wherein the first network video applications on the PC terminal applications transcode downloaded video contents directly into an audio and video encoding format and a video readable format that are compatible with the consumer electronic platform terminal.

5. The system according to claim 1, wherein the consumer electronics platform terminal searches for the presence of the PC terminal periodically.

6. A method for multi-screen integration and coordination, comprising:
at a consumer electronic platform, periodically and automatically searching for a proxy access on a PC terminal for performing uploading, downloading, transcoding and backup services;
at a command control service back end system, forwarding a control command from the consumer electronic platform to the PC terminal to control network video applications running on the PC terminal to perform uploading, downloading, transcoding and backup services and allow a remote viewing of media stream videos on the PC terminal;
transmitting video contents from the consumer electronics platform terminal to the PC terminal, wherein the PC terminal uploads the video contents to a back end server in a multi-thread process,
wherein the consumer electronics platform remotely controls the PC terminal to download the video contents and transcode the downloaded video contents into an audio and video encoding format and a video readable format that are compatible with the consumer electronics platform terminal, and
wherein the consumer electronic platform terminal synchronizes data to the PC terminal, and the PC terminal synchronizes the data to a back end service cluster subsystem.

7. The method according to claim 6, wherein, in a WAN, the consumer electronic platform terminal logs into a remote control command (CC) gateway, and by a bridging process between a remote command and services, communication channels are established remotely between the consumer electronic platform terminal and the PC terminal.

8. The method according to claim 6, wherein the consumer electronics platform terminal conducts searches for the PC terminal through the SSDP protocol of the UPnP standards, and uses the PC terminal as a proxy to perform uploading, downloading, transcoding and backup services through an access on the PC terminal.
